(19) United States
(12) Patent Application Publication
(10) Pub. No.: US 2012/0298695 A1
(43) Pub. Date: Nov. 29, 2012

(54) DISPENSING SYSTEM FOR A VISCOUS FLUID

(76) Inventor: Jerry Garrison, Leavenworth, KS (US)

(21) Appl. No.: 13/114,118

(22) Filed: May 24, 2011

(51) Int. Cl. B67D 7/84; B67D 3/00

(52) U.S. Cl. 222/175; 222/533

(57) ABSTRACT

The disclosure depicts a dispensing system for a viscous fluid. The system has a reservoir for containment of a fluid a pump removably insertable into an aperture in the recessed portion of the top of the reservoir, and the pump has an elongate handle having a spout adjacent a terminal end of the elongate handle. The pump handle may be selectively rotated from a stowed position to a dispensing position. In the dispensing position, a piston mechanism enables the handle to be selectively positionable between an initial position and a depressed position.

### BACKGROUND OF THE INVENTION

The importance of clean hands has become of increasing concern to many people. Hands frequently come into contact with people and items that are carriers of bacteria and disease causing germs.

Technology has addressed this concern by developing safe and effective germ-killing sanitizing lotions and liquids which are common at restaurants, hospitals, day cares and washrooms. For those who are commonly exposed to people and items that carry potentially harmful germs, there is an increased need to have sanitizing agents readily available and nearby. The inventive system is also well-suited for dispensing moisturizing lotions, suntan oils, sunscreen, or even topical medicines,

### SUMMARY OF THE INVENTION

The invention is a dispensing system for a viscous fluid, such as a hand sanitizer, lotion, suntan lotion, sunscreen, ointments, medicines, or any other fluid. The system co will include a reservoir having a bottom, a top, a rear wall and a front wall. The top is two-tiered with an upper portion and a recessed portion. The system will also include a pump removably insertable into an aperture in the recessed portion; the pump will also have an elongate handle having a spout adjacent a terminal end of the elongate handle. The pump will also include a dip tube with an open end that extends into the reservoir.

The pump of the inventive system will have a piston mechanism that the handle to he selectively positionable between an initial position and a depressed position: Fluid contained in the reservoir is inhaled through the dip tube and expelled from the spout as the handle is moved from the initial position to the depressed position. The elongate handle of the pump is rotatable about an axis passing through the dip tube. The handle is selectively rotatable from a stowed position to a dispensing position. In the stowed position, the elongate handle engages the upper portion of the top; in contrast, in a dispensing position, the handle is rotated to be clear of the upper portion so that it is downwardly displaceable to the depressed position,

In a preferred embodiment, the system has a clip engaging the reservoir and adapted to attach the reservoir to an article of clothing, such as a belt or waistline of a person. In a preferred embodiment of the invention, the clip is integrally formed on the reservoir to form a unitary, monolithic one-piece structure.

Optionally, the upper portion of the top includes a means for retaining the elongate handle in a stowed position. For example, a protuberance may be added to an upper surface of the top in order to frictionally engage and retain the elongate handle in a stowed position. Moreover, a lip may be formed to extend upwardly from the upper portion of the top. The lip should be formed to prevent thither rotation of the elongate handle past the lip.

The pump should be removably insertable into the aperture to enable one to refill the reservoir. In a preferred embodiment, the system includes a threaded sleeve positioned so that at least a portion of the dip tube passes through the sleeve. The aperture and sleeve may be cooperatively threaded to enable the sleeve to be screwed onto the reservoir.

Other objects, advantages and novel features of the present invention will become apparent from the following detailed description of the invention when considered in conjunction with the accompanying drawings.

### BRIEF DESCRIPTION OF THE DRAWINGS

FIG. 1 presents a perspective view isolating the reservoir portion of the inventive system, according to the principles of the invention.

FIG. 2 is a perspective view isolating the pump portion of the inventive system according to the principles of the invention.

FIG. 3 shows a perspective view of the system, shown with the pump handle in a stowed position.

FIG. 4 is a comparative perspective view of the system, shown with the pump handle in a dispensing position.

FIG. 5 is a rear perspective view of the system.

FIG. 6 is a side view of the system.

FIG. 7 is a top view of the system, shown with the pump handle in a stowed position.

### DETAILED DESCRIPTION OF THE PREFERRED EMBODIMENTS

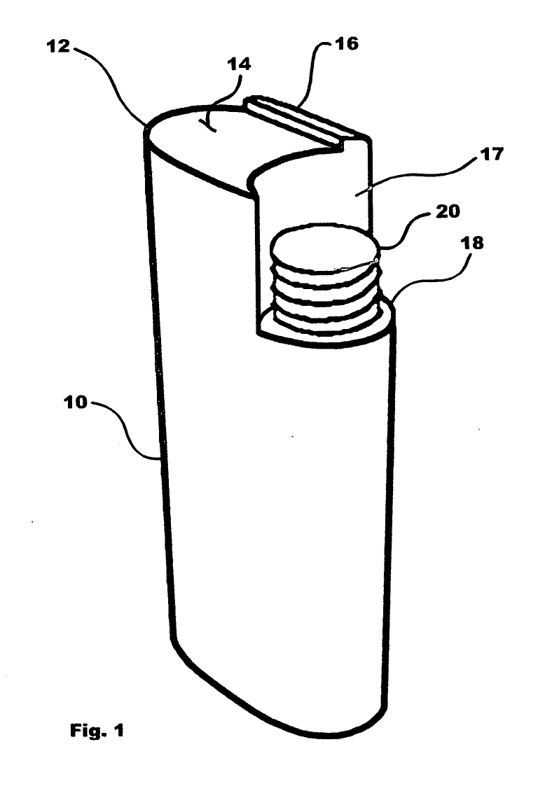

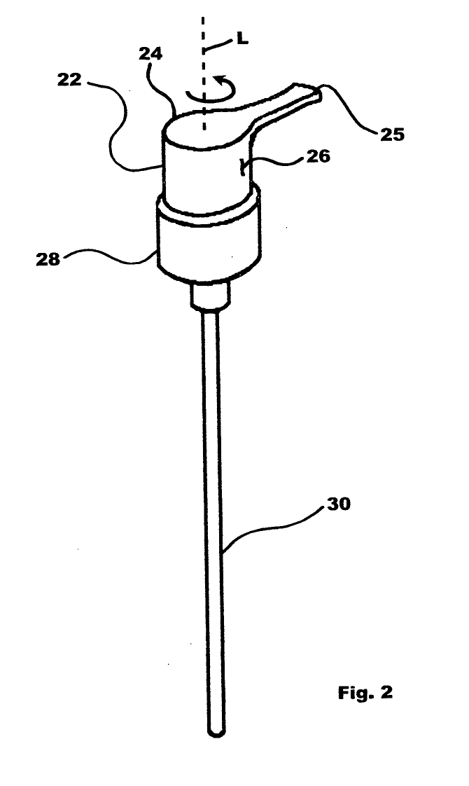

FIG. 1 is a perspective view detailing the parts of the reservoir 10. The reservoir 10 includes a two tiered top 12 having an upper portion 14 and a lower portion 18 that bears an aperture 20. The upper portion 14 of the top 12 has a lip 16 that extends upwardly from the upper portion 14, while the lower portion 18 of the top 12 bears an aperture 20 that is formed to receive a pump mechanism (not shown in FIG. 1, but see FIG. 2). Still referring to FIG. 1, a side wall 17 extends from the upper portion 14 to the lower portion 18. Preferably, the reservoir 10 should be designed such that a small clearance space separates the aperture 20 from the side wall 17, which would enable a sleeve (shown aft) to be screwed onto a threaded aperture 20 as shown.

FIG. 2 is a perspective view isolating the parts of the pump mechanism 22 of the system. The pump mechanism 22 hears an elongate pump handle 24 in fluid communication with a dip tube 30 having a terminus that will be submerged in fluid when the system is fully assembled. The pump handle 24 has a terminal end 25 that extends outwardly from an axis L that is substantially concentric with the dip tube 30. A discharge spout is adjacent the terminal end 25 of the pump handle 24.

Still referring to FIG. 2, the pump mechanism 22 will have a piston means 26 that will selectively enable displacement of the pump handle 24 with respect to a sleeve 28, which is formed to retain the dip tube 30 and also engage the aperture 20 of the reservoir 10 (Compare to FIG. 1).

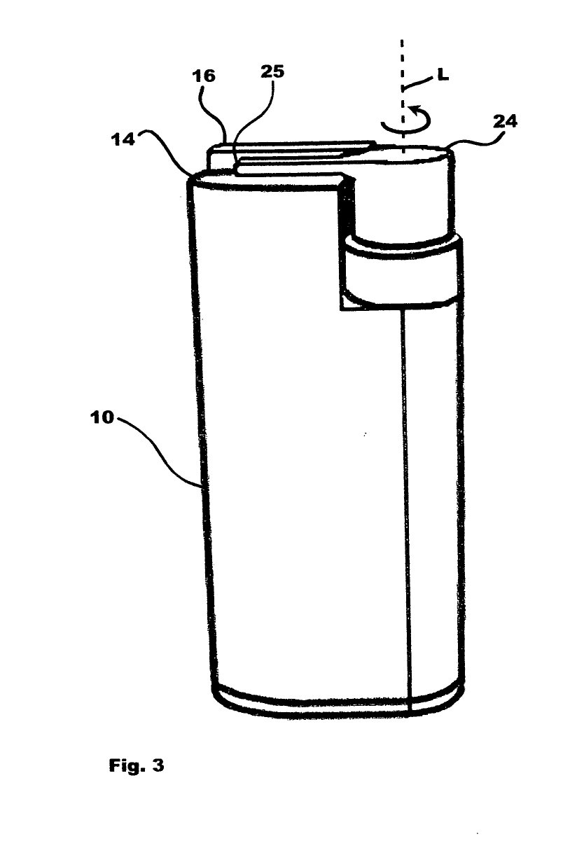

FIG. 3 shows a perspective view of the inventive system, shown with the pump handle 24 in the stowed position. In this stowed position, the terminal end 25 of the pump handle 24 engages the upper portion 14 of the top 12 of the reservoir 10. In a preferred embodiment, the terminal end 25 of the handle 24 may frictionally engage the upper portion 14. Note that the lip 16 formed along the top 14 extends upwardly to prevent further rotation of the terminal end 25 of the handle 24. Also, the system may be equipped with a retaining means that can frictionally engage and retain the handle 24 in a stowed position maintain the handle 24 in contact with lip 16) as shown until one desires to dispense fluid from the reservoir 10. If one desires to dispense fluid from the reservoir, the handle 24 may be selectively rotated to a dispensing position by turning the handle 24 about the axis L that is substantially concentric with the dip tube 30 (see FIG. 1) until the terminal end 25 of the handle no longer engages the upper portion 14 of the top 12 of the reservoir 10.

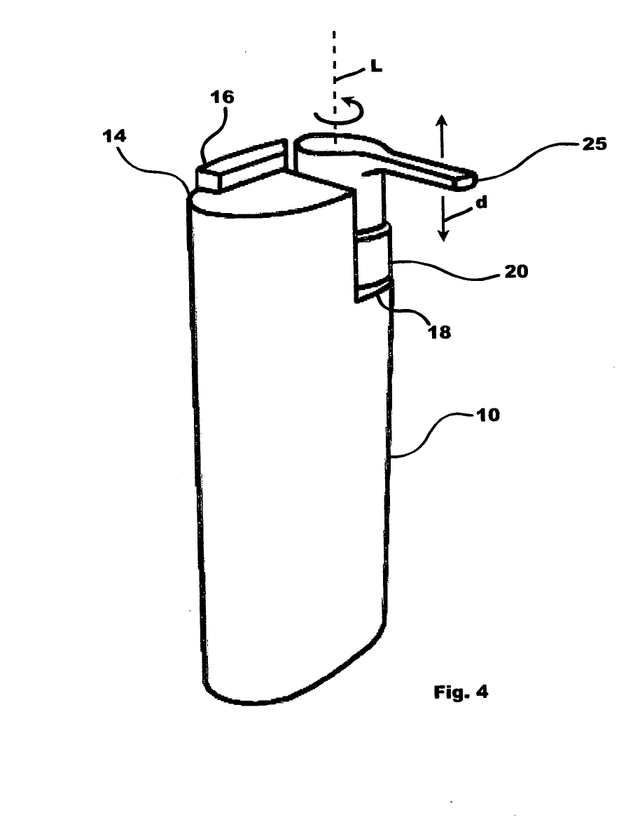

FIG. 4 is a comparative perspective view that shows the system with its handle 24 in a dispensing position. As shown, the terminal end 25 of the handle 24 is disengaged from the upper portion 14 of the top 12 of the reservoir by rotating the handle about axis L as shown.

in the dispensing position as shown in FIG. 4, the handle 25 is displaceable relative the sleeve 20 by depressing the handle 25 in direction d, which results in fluid contained within the reservoir 10 being inhaled through the dip tube 30 (see FIG. 2) being expelled from a discharge spout positioned adjacent the terminal end 25 of the handle 24.

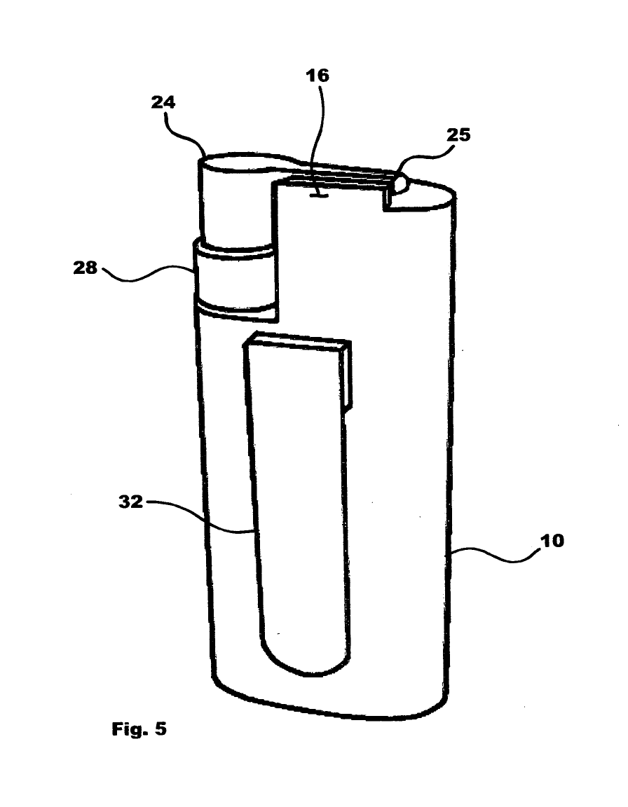

FIG. 5 shows a perspective view of the system, shown from a rear view with the handle 24 in the stowed position. The rear wall of the reservoir 10 preferably includes a clip 32 configured to engage a portion of a person's clothing, such as a waistline, belt, or even a pocket. When the clip 32 attaches the reservoir 10 to a person, the handle 24 may be manually rotated from the stowed position (shown), to a position wherein the terminal end 25 of the handle is distal the wearer. Also, the lip 16 acts prevent contact with the terminal end 25 (and any fluid that might be thereon) with the wearer's clothing.

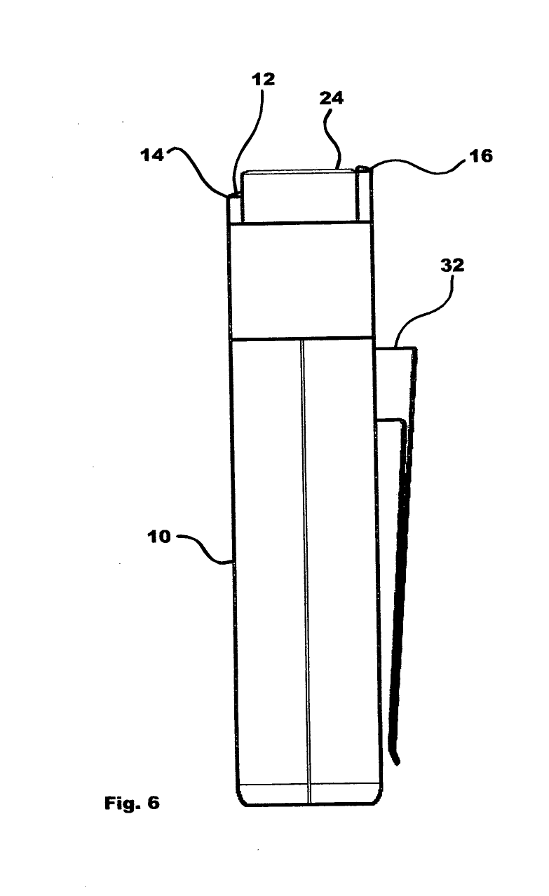

FIG. 6 shows a side view of the reservoir 10. The clip 32 may be integrally formed with the reservoir to form a unitary, monolithic one piece structure,:, and should be deflectable outward from the reservoir 10 in order to slide over and frictionally engage the wearer's apparel. As apparent from this side view of FIG. 6, the lip 16 formed at the upper portion 14 of the top 12 of the reservoir 10 should protrude above the height of the handle 24 (See FIG. 5).

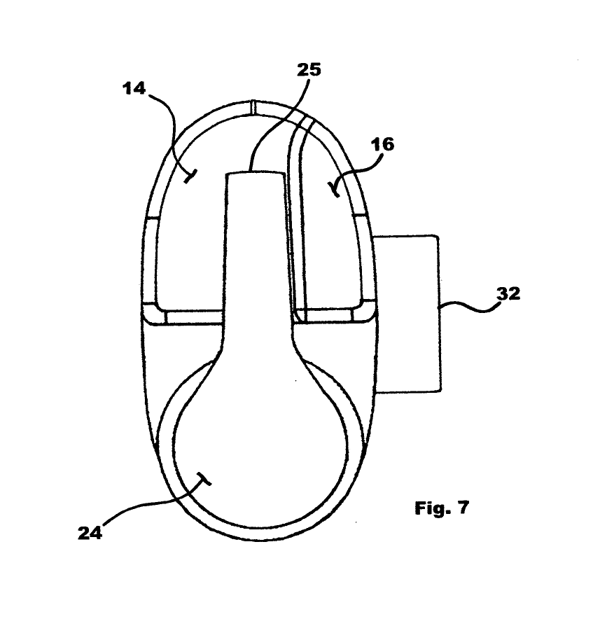

FIG. 7 shows an overhead plan view of the reservoir 10. As shown, the terminal end 25 of the handle 24 engages against the lip 16 formed on the top portion 14 of the reservoir 10. The lip 16 is formed to he of sufficient height to prevent further rotation of the terminal end 25 past the lip 16.

Having described the invention and its drawings and diagrams in detail, it is to be understood that these descriptions are for illustrative purposes. The scope and breadth of the invention shall be limited only by the appended claims.

My invention is:

1. A dispensing system for a viscous fluid, the system comprising;
a reservoir for containment of a fluid, the reservoir having a bottom, a top, a rear wall and a front wall;
the top having an upper portion and a recessed portion;
a pump removably insertable into an aperture in the recessed portion of the top;
the pump having
an elongate handle having a spout adjacent a terminal end of the elongate handle;
a dip tube having an open end extending into the reservoir, the elongate handle being rotatable about an axis passing through the dip tube;
a piston mechanism enabling the handle to be selectively positionable between an initial position and a depressed position; wherein, fluid contained in the reservoir is inhaled through the dip tube and expelled from the spout as the handle is moved from the initial position to the depressed position;
and wherein, the handle is selectively rotatable from a stowed position wherein the handle engages the upper portion of the top, and a dispensing position wherein the handle is displaceable to the depressed position,

2. The system as in claim 1, further comprising a clip engaging the reservoir and adapted to attach the reservoir to an article of clothing.

3. The system as in claim 2, wherein the. clip and bottle comprise a unitary, monolithic one-piece structure,

4. The system as in claim 1, wherein the clip extends from the rear wall

5. The system as in claim 1, the fluid comprising hand sanitizer.

6. The system as in claim 1, wherein the upper portion of the top includes a means for retaining the elongate handle in a stowed position.

7. The system as in claim 1 further comprising
a lip extending upwardly from the upper portion of the top, the lip configured and formed to prevent further rotation of the elongate handle past the lip.

8. The system as in claim 1, further comprising
a threaded sleeve positioned so that at least a portion of the dip tube passes through the sleeve;
threading on the aperture; and,
the sleeve and aperture are (*operatively formed to enable the pump to be screwed onto the reservoir.
